(19) United States
(12) Patent Application Publication
(10) Pub. No.: US 2003/0069010 A1
(43) Pub. Date: Apr. 10, 2003

(54) Systems and techniques for testing a communications device

(76) Inventor: Srinivasa Eravelli, San Diego, CA (US)

Correspondence Address: QUALCOMM Incorporated, Attn: Patent Departmen, 5775 Morehouse Drive, San Diego, CA, 92121-1714, US

(21) Appl. No.: 09/975,098

(22) Filed: Oct. 10, 2001

(51) Int. Cl. H04Q 7/20

(52) U.S. Cl. 455/423; 455/115; 455/425

(57) ABSTRACT

Systems and techniques for testing a unit using a communications device simulator and an access point simulator. The results of the simulations are evaluated by a controller. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or the meaning of the claims.

### BACKGROUND

1. Field

The present invention relates to communications systems, and more specifically, to systems and techniques for testing units within a communications system.

2. Background

Modern communications systems are designed to allow multiple users to share a common communications medium. One such communications system is a code division multiple access (CDMA) system. The CDMA communications system is a modulation and multiple access scheme based on spread-spectrum communications. In a CDMA communications system, a base station controller (BSC) provides an interface between a network infrastructure and all base stations dispersed throughout a geographic region. The network infrastructure can be a packet based network, such as the Internet or a corporate Intranet, a public switched data network (PSTN), or any other suitable network. The geographic region is generally subdivided into smaller regions known as cells. Each base station is configured to serve all subscriber stations in its respective cell. In some high traffic applications, the cell may be divided into sectors with a base station serving each sector. Each user may access the network infrastructure, or communicate with other subscriber stations, through one or base stations under control of the BSC.

Various test methods and devices have been developed to verify the functionality of a base station before it is installed in the field. The testing can include unit level tests of a portion of the base station or a total integration test of the entire base station. These tests typically measure the performance of the base station which is compared with system requirements.

One method for testing a base station includes the use of an actual BSC and a subscriber station to establish and tear down connections with the base station. In this test configuration, hundreds of attempts are made to establish and tear down connections between the base station and a subscriber station. During the test, data is generated by both the BSC and subscriber station which contain information such as the types of messages that were sent and received by the BSC and subscriber station and the occurrence of dropped connections. The data is stored in the memory of the BSC and the subscriber station. After testing of the base station is completed, the data from the BSC and subscriber station are correlated with one another and analyzed for anomalies. A distinct disadvantage associated with this method for base station testing is that the data generated by the BSC and subscriber station are not correlated with one another in real time. Also, the use of an actual BSC and subscriber station limits the range of possible test scenarios due to the functional limitations of the BSC and subscriber station.

Another method for testing a base station utilizes a separate simulator for either the BSC or the subscriber station, or separate simulators for both devices. The BSC and subscriber station simulators are typically implemented with test hardware controlled by test software so as to mimic the functionality of an actual BSC or subscriber station, respectively. While the use of a BSC or subscriber station simulator provides an expanded range of test capabilities, this test method still suffers from a lack of real time correlation of the data from the BSC simulator and the subscriber station simulator. This problem is not limited to CDMA systems, and there exists a need for a new testing methodology applicable to a wide range of applications.

### SUMMARY

In one aspect of the present invention, a test fixture includes a communications device simulator, an access network simulator, and a controller coupled to the communications device simulator and the access network simulator.

In another aspect of the present invention, a test fixture includes a communications device simulator, an access network simulator, and a simulator board having the communications device simulator and the access network simulator thereon.

In a further aspect of the present invention, a method of testing a unit includes simulating a communications device to communicate with a unit under test, simulating an access network to communicate with the unit under test, and correlating in real time the communications of the simulated communications device and the simulated access network.

In yet a further aspect of the present invention, a method of testing a unit includes communicating between a communications device simulator and a unit under test, communicating between an access network simulator and the unit under test, generating data by each of the simulators in response to its respective communications, and coupling the data from each of the simulators to a controller to evaluate the unit under test.

In another aspect of the present invention, a test fixture includes first simulation means for simulating a communications device, second simulation means for simulating an access network, and controller means, coupled to the first and second means, for evaluating a unit under test.

In yet another aspect of the present invention, computer readable media embodying a method of testing simulating a communications device to communicate with a unit under test, simulates an access network to communicate with the unit under test, and correlates in real time the communications of the simulated communications device and the simulated access network.

It is understood that other aspects of the present invention will become readily apparent to those skilled in the art from the following detailed description, wherein is shown and described only exemplary embodiments of the invention, simply by way of illustration. As will be realized, the invention is capable of other and different embodiments, and its several details are capable of modifications in various respects, all without departing from the invention. Accordingly, the drawings and description are to be regarded as illustrative in nature, and not as restrictive.

### BRIEF DESCRIPTION OF THE DRAWINGS

Aspects of the present invention are illustrated by way of example, and not by way of limitation, in the accompanying drawings in which like reference numerals refer to similar elements:

FIG. 1 is a block diagram of an exemplary test fixture in communication with a unit under test;

FIG. 2 is a block diagram of an exemplary test fixture in communication with a unit under test via a router;

FIG. 3 is a functional block diagram of an exemplary test fixture;

FIG. 4 is a flow chart illustrating an exemplary test scenario performed by a test fixture in communication with a unit under test; and

FIG. 5 is an exemplary illustration of the electronic packaging of the test fixture.

### DETAILED DESCRIPTION

The detailed description set forth below in connection with the appended drawings is intended as a description of exemplary embodiments of the present invention and is not intended to represent the only embodiments in which the present invention can be practiced. The term Aexemplary@ used throughout this description means Aserving as an example, instance, or illustration,@ and should not necessarily be construed as preferred or advantageous over other embodiments. The detailed description includes specific details for the purpose of providing a thorough understanding of the present invention. However, it will be apparent to those skilled in the art that the present invention may be practiced without these specific details. In some instances, well known structures and devices are shown in block diagram form in order to avoid obscuring the concepts of the present invention.

In an exemplary testing methodology, a test fixture can be can be used to generate various test scenarios to verify the operation of a unit under test. The test fixture can be adapted to simulate one or more communications devices. The communications device simulated by the test fixture can be any type of communications device, including by way of example, a mobile or stationary subscriber station. The simulated communications device functions as a transceiver in communication with an access network. An access network includes an access point which is any means by which one or more communication devices can communicate with a network infrastructure. By way of example, an access point may include a base station controller which in combination with a base station constitutes an access network. An access network is generally used to increase the geographic coverage supported by a single access point. In the described exemplary embodiment, the test fixture can also simulate any type of access point, including by way of example, a base station controller which, in conjunction with the communications device simulator, provides a testing platform for a base station. The simulation of both the communications device and the access point for testing a base station facilitates real time analysis of test results.

Although various aspects of the present invention are described in the context of a testing methodology for CDMA communications, those skilled in the art will appreciate that the techniques for testing a unit described herein are likewise suitable for use in various other communications environments. Accordingly, any reference to a CDMA communications system is intended only to illustrate the inventive aspects of the present invention, with the understanding that such inventive aspects have a wide range of applications.

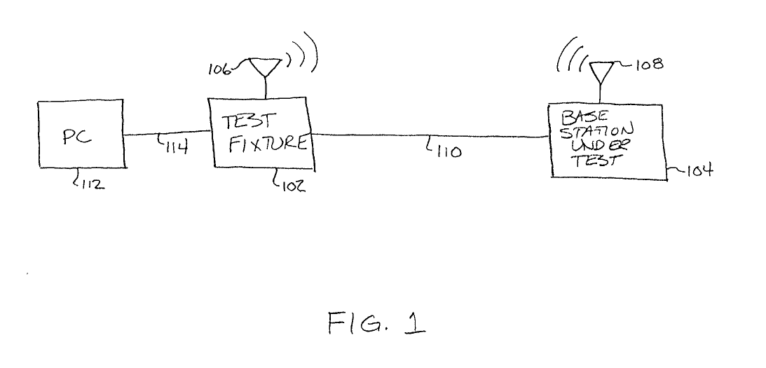

FIG. 1 is a block diagram of an exemplary test fixture 102 in communication with a unit under test 104, such as a base station for CDMA applications. The test fixture 102 can be configured to simulate both the BSC and subscriber station functions. In the described exemplary embodiment, the test fixture 102 includes an antenna 106 for maintaining a wireless link with the base station under test 104 via a base station antenna 108. The wireless link can be used to support simulated subscriber station communications. The base station under test 104 is further coupled to the test fixture 102 by an Ethernet connection 110 for simulated BSC communications. The Ethernet connection 110 provides a packet based transport system to simulate a BSC connection, although any electrical connection which can support data and voice communications can be used. Alternatively, a wireless connection, e.g., an infrared-based or radiowave-based local area network connection, between the test fixture 102 and the base station under test 104 can be used in place of the Ethernet connection. This approach eliminates the need to connect and disconnect the Ethernet cable from the base station under test 104 and may provide for a greater range of proximity during testing. A personal computer (PC) 112 can be coupled to the test fixture 104 for user interactive test applications. The PC connection can be a standard Ethernet connection 114, or alternatively, a wireless link for greater test configuration flexibility. Alternatively, the test fixture 102 can be equipped with an internal processor (not shown) for automatic testing without the need for a PC 112.

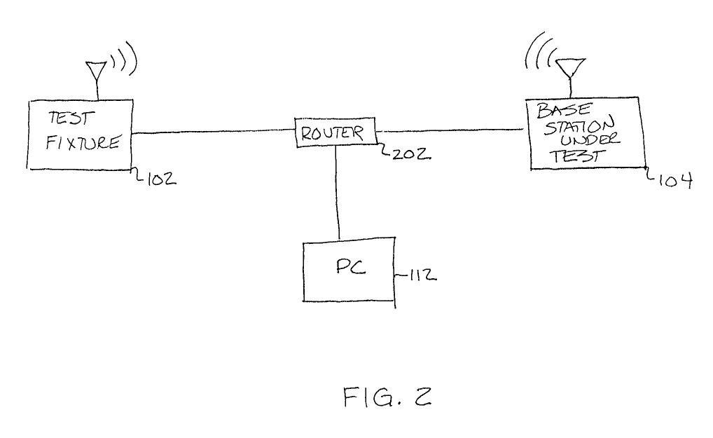

FIG. 2 is a block diagram of the exemplary test fixture 102 in communication with the base station under test 104 via a router 202. This approach is particularly attractive for use with test fixtures lacking a Universal Serial Bus port to support a PC. In this configuration, the PC 112 can be connected to the router 202 using an Ethernet connection. The router 202 can also support an Ethernet connection between the test fixture 102 and the base station under test 104. The Ethernet connection can be replaced with any other packet based connection known in the art, or a wireless link. The router 202 can be a Cisco Catalyst Series 5000 which is manufactured by Cisco Systems, Inc., located in San Jose, Calif., or any other conventional router.

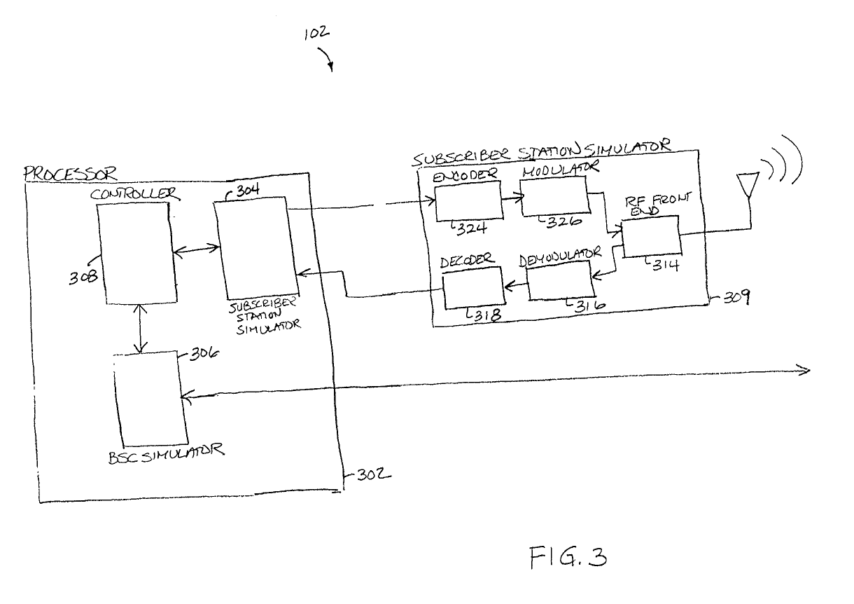

FIG. 3 is a block diagram of the exemplary test fixture 102 adapted for CDMA applications. The exemplary test fixture 111 includes a processor 311 with a subscriber station simulator 314 and a BSC simulator 316f Alternatively, the subscriber station simulator 314 or the BSC simulator 316 can be implemented external to the processor 311f The processor 311 also includes a controller 318 for generating the test scenarios applied to the base station under test, controlling the timing of the simulators, and analyzing the results of the simulationsf The processor 302 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof. In at least one embodiment, the processor 302 can be implemented with a microprocessor such as a PowerPC Processor, part number PPCEC603, which is manufactured by Motorola, located in Schaumberg, Ill.

The subscriber station simulator 304 and the BSC simulator 306 can be implemented with software stored in program memory for execution by the processor 302. The controller 308 can be implemented in a test application layer on top of the subscriber station simulator 304 and the BSC simulator 306. The test application layer can be configured to support interactive and automated test applications. Interactive test applications can be adapted for user issued test commands from a PC (not shown) or other control device. The test results can be monitored from the PC and transmitted to a remote site for further study and analysis.

In the described exemplary embodiment, the subscriber station simulator 304 can utilize the functionality of an existing integrated circuit for an actual subscriber station transceiver 309. By way of example, the transceiver can be an ASIC such as a MSM5500 which is designed by Qualcomm, located in San Diego, Calif., and manufactured by IBM, located in Armonk, N.Y. Alternatively, the transceiver 309 can be integrated into the subscriber station simulator 308 in the processor 302, or implemented in a separate general purpose processor, a DSP, a FPGA or other programmable logic device, discrete gate or transistor logic, discrete hardware components, or any combination thereof.

The described exemplary test fixture can support various base station designs, and those skilled in the art will readily be able to adapt the test fixture to such base station designs in accordance with the concepts described throughout. For the purposes of explanation, an exemplary base station under test receives communications from the BSC simulator 306, partitions the communications into packets and encodes the packets. The encoded packets are then scrambled and covered with Walsh covers. The scrambled packets are punctured with a pilot signal and reverse power control (RPC) bits, and quadrature modulated with short PN codes. The modulated packets are upconverted, filtered, amplified and transmitted back to the test fixture on a forward link transmission. The forward link refers to the transmission from the base station under test to the subscriber station transceiver 309.

The exemplary subscriber station transceiver 309 is configured to support a wireless link with the base station under test. In this exemplary embodiment, the subscriber station transceiver 309 includes an RF front end 314. The RF front end 314 includes a receiver and transmitter. The receiver provides filtering, amplification, down-conversion, and analog-to-digital signal conversion. The packets output from the RF front end 314 are coupled to a demodulator 316 where they are quadrature demodulated with the short PN codes. The pilot signal and the RPC bits are then removed from the packets, and the packets are decovered with the Walsh covers and descrambled. The descrambled packets are then provided to a decoder 318 which performs the inverse of the signal processing functions done at the base station under test. The encoded packets are then provided to the subscriber station simulator 302 for processing.

The controller 308 also initiates communications for a reverse link transmission. The reverse link refers to the transmission from the subscriber station transceiver 309 to the base station under test. The subscriber station simulator 302 provides communications to an encoder 324 in the subscriber station transceiver 309. The encoder 324 partitions the communications into packets, and encodes the packets. The encoded packets are provided to a modulator 326 where they are spread with a long PN code, covered with Walsh codes, and quadrature modulated with the short PN codes. The modulated packets are summed with control messages from the encoder 324. In the described exemplary embodiment, the control messages are covered with a Walsh cover and quadrature modulated with the short PN codes in the encoder 324 before they are summed with the modulated packets in the modulator 326. The summed modulated packets are then provided to the transmitter in the RF front end 314 for upconversion, amplification, filtering, and transmission over the reverse link.

The reverse link transmission from the subscriber station transceiver 309 is received by the base station under test. The base station under test filters, amplifies, downconverts, and digitizes the reverse link transmission. The packets are then quadrature demodulated, decovered by the Walsh codes, and despread by the long PN code. The control messages are then extracted from the packets, and the packets are depacketized and provided to the BSC simulator 306 over an Ethernet connection for processing.

The exemplary controller 308 can be configured to support various test scenarios. Functional tests can be implemented to confirm the functional requirements of the unit under test in accordance with a test specification. The controller 308 may also support regression tests which may involve the comprehensive retest of software after making modifications in order to determine if the modified code has regressed in its ability to meet its requirements. Load tests may also be supported by the controller wherein the unit under test is pushed to its maximum capacity in terms of supporting a large number of communications devices. Under these conditions, the response time and the performance of the unit under test can be evaluated. Adversarial tests can also be performed which tests the units ability to deal with unexpected and abnormal conditions such as invalid or incomplete messages, events out of sequence, and software or hardware related failures.

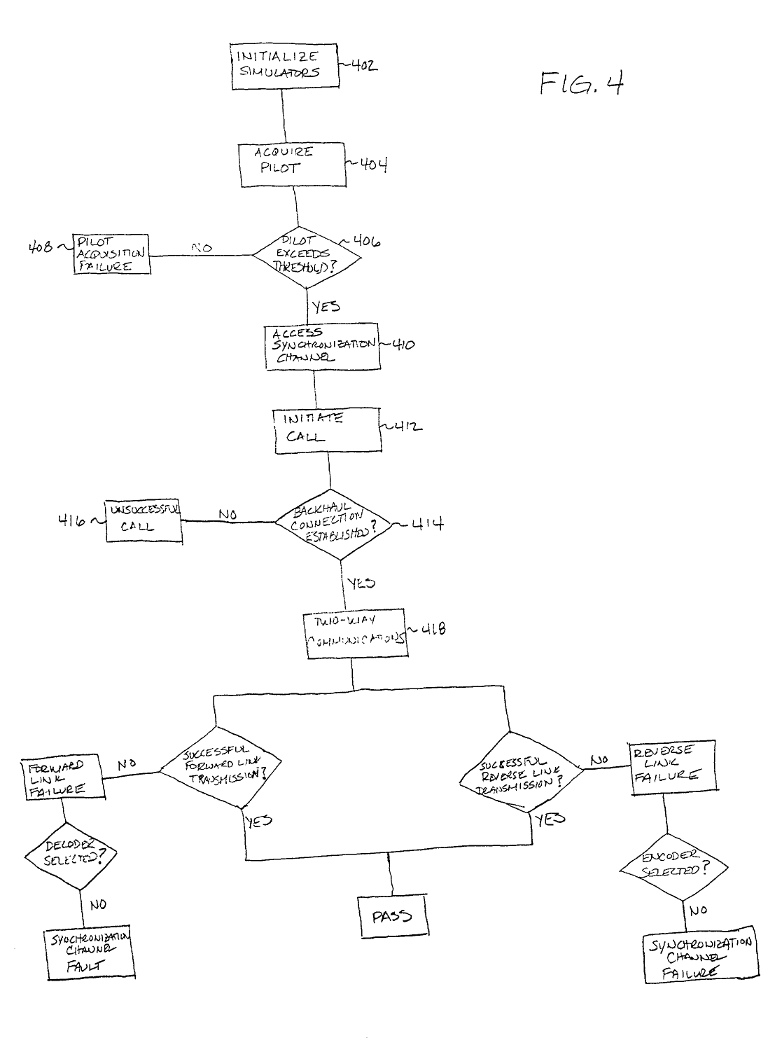

FIG. 4 is a flow chart illustrating an exemplary test scenario performed by the controller for automated testing of a base station. Those skilled in the art will appreciate that numerous other test scenarios can be performed using the concepts and principles described throughout. The exemplary test scenario may be initiated automatically by the controller, or alternatively selected by the user. For automated applications, the exemplary test scenario can be configured to exercise numerous functions of the base station under test. By way of example, a test scenario can be run which involves numerous test functions including acquisition, control messaging, call setup and tear down, and forward and reverse link communications.

Referring to FIG. 4, the controller executes a test scenario for verifying the operation of the base station under test. In step 402, the controller initializes the BCS simulator and the subscriber station simulator. Once initialized, the subscriber station simulator will attempt to establish a communications link with the base station under test using an access procedure. In step 404, the access procedure involves the acquisition of a pilot signal transmitted over the forward link by the base station under test. The subscriber station simulator correlates the forward link transmission with a short PN code to extract the pilot signal and measure its power. The pilot signal power is then compared against a power threshold, and the results are reported to the controller in step 406. In step 408, the controller records a pilot signal acquisition failure if the power of the pilot signal is below the threshold. If the power of the pilot signal exceeds the threshold, the acquisition of the pilot signal has been successful, and the base station under test is added to the active set for the subscriber station simulator.

Once the subscriber station simulator acquires the pilot signal, it can communicate with the base station under test through various control and traffic channels. The control and traffic channels can be created by spreading each channel with a different orthogonal inner code generated by using Walsh functions. Additional channels can be created by a time-division-multiplexing scheme. The control channels include, by way of example, a synchronization channel and a paging channel. In step 408, the subscriber station simulator accesses the synchronization channel to acquire broadcast system information. The system information identifies the base station under test in addition to other system timing information such as the vocoders used by the base station under test and the long PN codes. Once the system information is acquired, the subscriber station simulator monitors the paging channel for a call.

In step 412 a call can be initiated by the controller for the subscriber station, or alternatively, the controller can prompt the subscriber station to initiate the call. In the case where the call is for the subscriber station, the BSC simulator generates call signaling messages and directs the base station under test to page the subscriber station simulator. A paging message is then sent out by the base station under test to the subscriber station simulator on the paging channel indicating that a call has arrived. In response, the subscriber station simulator transmits a control message over an access channel back to the base station under test indicating that it is ready to receive the call. In the case where the subscriber station simulator initiates the call, the access channel is also used to transmit control messages to the base station under test indicating that the subscriber station is ready to place a call. Either way, in response to communications over the access channel, the base station under test establishes a backhaul connection with the BSC simulator. In step 414, the controller monitors the BCS simulator to confirm that the backhaul connection has been established. If the backhaul connection has not been established, the controller records an unsuccessful call in step 416. The unsuccessful call could be due to a corrupted control or access channel, a backhaul connection failure between the base station under test and the BSC simulator, or other related failure. Additional tests can be performed either automatically or manually to further isolate the source of failure.

With the backhaul connection established between the BSC simulator and the base station under test, and the traffic channel established between the base station under test and the subscriber station simulator, two-way communications can occur in step 418. The forward link traffic channel can be tested first by generating communications in the controller and transmitting them to the BSC simulator. The BSC simulator transmits the communications to the base station under test, which in turn, transmits the communications over the forward link to the subscriber station simulator. If the communications include voice, the subscriber station simulator invokes voice decompression algorithms corresponding to the base station vocoder information received by the subscriber station simulator on the synchronization channel. The controller then compares the communications received by the subscriber station simulator with that originally generated by the controller. If the comparison fails, the controller records a forward link traffic channel failure 420. If the forward link traffic channel failure occurs during the transmission of voice, additional tests can be performed either automatically or manually to determine whether the cause of the failure was due to an incorrect voice decompression algorithm selected by the subscriber station simulator. If the voice decompression algorithm is determined to be the source of the failure, a synchronization channel fault may be recorded by the controller in step 422.

The reverse link traffic channel can be tested in a similar manner. The controller generates communications and transmits them to the subscriber station simulator. The subscriber station simulator transmits the communications over the reverse link to the base station under test, which in turn, transmits the communications to the BSC simulator. If the communications include voice, the subscriber station simulator invokes a vocoder corresponding to the base station vocoder indicated in the synchronization channel. The controller then compares the communications received by the BSC simulator with that originally generated by the controller. If the comparison fails, the controller records a reverse link traffic channel failure in step 424. If the reverse link traffic channel failure occurs during the transmission of voice, additional tests can be performed either automatically or manually to determine whether the cause of the failure was due to an incorrect voice compression algorithm selected by the subscriber station simulator. If the voice compression algorithm is determined to be the source of the failure, a synchronization channel fault may be recorded by the controller in step 426.

In at least one embodiment, the controller can be configured to push the base station under test to its maximum capacity. This can be achieved by simulating a large volumes of calls at the test fixture. In this embodiment, the subscriber station simulator generates numerous control messaging scenario over the access channel to simulate multiple subscriber stations. The control messages for each simulated subscriber station can be in response to a paging message from the base station under test, or initiated by the subscriber station simulator. In response to the control messages, the base station under test establishes a separate backhaul connection with the BCS simulator for each subscriber station simulated by the test fixture. The controller monitors the BSC simulator to confirm a backhaul connection for each simulated subscriber station. The test scenario can further be adapted to dynamically simulate hundreds of connections and disconnections to determine whether the establishing and tearing down of backhaul connections result in an unacceptable amount of dropped calls.

Although the exemplary test scenario has been described sequentially, those skilled in the art will appreciate that the sequence of the test functions may be altered. Since the BSC simulator and the subscriber station simulator are state independent machines, the test functions can be performed in any order. By way of example, the test fixture can perform the two-way communications test function without first performing pilot acquisition. This test scenario would not be possible with an actual subscriber station which requires pilot acquisition before prior to establishing a communications link. In some embodiments, the sequence of test functions may modified in progress, either automatically or manually, depending on the test results.

Those skilled in the art will further recognize that the described exemplary test scenario can be modified to include additional test functions. By way of example, some base stations include a variable data rate feature to maximize the data rate that can be supported by the subscriber station based on the carrier-to-interference ratio. This function can be tested by transmitting a data rate control (DRC) message from the subscriber station simulator to the base station under test and tracking the data rate of the reverse link transmission in accordance with the DRC message.

Another test function can be added to test a power control loop in the base station under test. In CDMA applications, a power control loop can be utilized to adjust the power of the connected subscriber stations to minimize interference on the reverse link and maximize user capacity. This function can be tested by varying the power of the reverse link transmission. In response to the power variations, the RPC bits generated by the base station under test can be tracked to ensure that they vary accordingly.

A further test function can be implemented to test the ability of the base station under test to deal with corrupted forward link transmissions. This can be accomplished by simulating periodic negative acknowledgment (NACK) messages at the subscriber station simulator indicating that the forward link transmission is corrupted. The NACK messages generated by the subscriber station simulator can be transmitted to the base station under test where they are demodulated, decoded and transmitted to the BCS simulator. Upon processing the NACK message, the BSC simulator directs the base station under test to take any number of remedial actions such as retransmitting the communications to the subscriber station simulator. In response to a simulated NACK message, if the subscriber station simulator does not receive a retransmission, the controller can record an NACK failure.

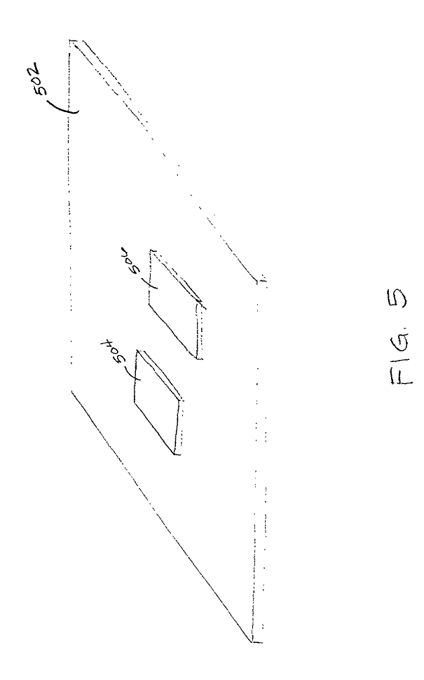

The test fixture electronics can be packaged in a variety of ways. By way of example, the simulators can be arranged on a circuit board as shown in FIG. 5. The circuit board 502 can take on various forms including a printed circuit board. A microprocessor 504 implementing the processor and an ASIC 506 implementing the subscriber station simulator are shown mounted on the printed circuit board 502.

Alternatively, the test fixture can be configured as a removable module in a base station under test. A conventional base station includes a number of circuit boards mounted in a card cage and interconnected through a backplane. In at least one embodiment, the card cage can be provided with an additional slot which is wired to the other circuit cards through the backplane. The test fixture can be inserted into the slot to test the base station and removed once the test is complete.

Those skilled in the art will appreciate that the various illustrative logical blocks, modules, circuits, and algorithms described in connection with the embodiments disclosed herein may be implemented as electronic hardware, computer software, or combinations of both. To clearly illustrate this interchangeability of hardware and software, various illustrative components, blocks, modules, circuits, and algorithms have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

Although exemplary embodiments of the present invention has been described, it should not be construed to limit the scope of the appended claims. Those skilled in the art will understand that various modifications may be made to the described embodiments. Moreover, to those skilled in the various arts, the invention itself herein will suggest solutions to other tasks and adaptions for other applications. It is therefore desired that the present embodiments be considered in all respects as illustrative and not restrictive, reference being made to the appended claims rather than the foregoing description to indicate the scope of the invention.

What is claimed is:

1. A test fixture, comprising:
a communications device simulator;
an access point simulator; and
a controller coupled to the communications device simulator and the access point simulator.

2. The test fixture of claim 1 wherein the communications device simulator comprises a subscriber station simulator, and the access point simulator comprises a base station controller simulator.

3. The test fixture of claim 2 wherein the subscriber station simulator comprises a mobile data communications device simulator.

4. The test fixture of claim 2 wherein the subscriber station simulator comprises a mobile telephone simulator.

5. The test fixture of claim 1 further comprising a simulator board having the communications device simulator and the access point simulator thereon.

6. The test fixture of claim 1 wherein the access point simulator comprises an Ethernet port configured to communicate with a unit under test.

7. The test fixture of claim 1 wherein the communications device simulator is configured to communicate with a unit under test through a wireless link.

8. The test fixture of claim 7 wherein the communications device simulator is configured to communicate with the unit under test using code division multiple access

9. The test fixture of claim 8 wherein the communications device simulator is further configured to communicate with the unit under test using code and time division multiple access.

10. The test fixture of claim 1 wherein the controller is configured to correlate in real time communications of both the communications device simulator and the access point simulator with a unit under test.

11. The test fixture of claim 1 wherein the communications device simulator is configured to establish a first communications link with a unit under test, and in response to the establishment of the first communications link, the access point simulator is configured to establish a second communications link with the unit under test for the communications device simulator.

12. A test fixture, comprising:
a communications device simulator;
an access point simulator; and
a simulator board having the communications device simulator and the access point simulator thereon.

13. The test fixture of claim 12 wherein the communications device simulator comprises a subscriber station simulator, and the access point simulator comprises a base station controller simulator.

14. The test fixture of claim 13 wherein the subscriber station simulator comprises a mobile data communications device simulator.

15. The test fixture of claim 13 wherein the subscriber station simulator comprises a mobile telephone simulator.

16. The test fixture of claim 12 wherein the access point simulator comprises an Ethernet port configured to communicate with a unit under test.

17. The test fixture of claim 12 wherein the communications device simulator is configured to communicate with a unit under test through a wireless link.

18. The test fixture of claim 17 wherein the communications device simulator is configured to communicate with the unit under test using code division multiple access

19. The test fixture of claim 18 wherein the communications device simulator is further configured to communicate with the unit under test using code and time division multiple access.

20. The test fixture of claim 12 further comprising a controller coupled to the communications device simulator and the network access simulator.

21. The test fixture of claim 20 wherein the controller is configured to correlate in real time communications of both the communications device simulator and the access point simulator with a unit under test.

22. The test fixture of claim 12 wherein the communications device simulator is configured to establish a first communications link with a unit under test, and in response to the establishment of the first communications link, the access point simulator is configured to establish a second communications link with the unit under test for the communications device simulator.

23. A method of testing a unit, comprising
simulating a communications device to communicate with a unit under test;
simulating an access point to communicate with the unit under test; and
correlating in real time the communications of the simulated communications device and the simulated access point.

24. The method of claim 23 wherein the simulation of the communications device is configured to communicate with the unit under test using a wireless link.

25. The method of claim 24 wherein the simulation of the communications device is further configured to communicate with the unit under test using code division multiple access to communicate with the unit under test.

26. The method of claim 25 wherein simulation of the communications device is further configured to communicate with the unit under test using code and time division multiple access to communicate with the unit under test.

27. The method of claim 23 wherein the simulation of the access point is configured to communicate with the unit under test using an Ethernet connection.

28. The method of claim 23 wherein the simulation of the communications device is configured to establish a first communications link with the unit under test, and the simulation of the access point is configured to attempt to establish a second communications link with the unit under test for the simulated communications device in response to the establishment of the first communications link.

29. The method of claim 28 wherein the correlation of the communications of the simulated communications device and the simulated access point comprises declaring a fault if the second communications link is not established in response to the establishment of the first communication link.

30. The method of claim 23 wherein the simulation of the communications device comprises simulating a subscriber station to communicate with the unit under test, and the simulation of the access point comprises simulating a base station controller to communicate with the unit under test.

31. A method of testing a unit, comprising:
communicating between a communications device simulator and a unit under test;
communicating between an access point simulator and the unit under test;
generating data by each of the simulators in response to its respective communications; and
coupling the data from each of the simulators to a controller to evaluate the unit under test.

32. The method of claim 31 wherein the controller evaluates the data from each of the simulators in real time.

33. The method of claim 31 wherein the communications between the communications device simulator and the unit under test is performed over a wireless link.

34. The method of claim 33 wherein the communications between the communications device simulator and the unit under test is performed using code division multiple access.

35. The method of claim 34 wherein the communications between the communications device simulator and the unit under test is performed using code and time division multiple access.

36. The method of claim 31 wherein the communications between the access point simulator and the unit under test is performed over an Ethernet network.

37. The method of claim 31 wherein the communications between the communications device simulator and the unit under test comprises establishing a first communications link, and the communications between the access point simulator and the unit under test comprises attempting to establish a second communications link for the simulated communications device in response to the establishment of the first communications link.

38. The method of claim 37 wherein the evaluation of the data by the controller comprises declaring a fault if the second communications link is not established in response to the establishment of the first communication link.

39. The method of claim 31 wherein the communications device simulator comprises a subscriber station simulator, and the access point simulator comprises a base station controller simulator.

40. The method of claim 39 wherein the subscriber station simulator comprises a mobile data communications device simulator.

41. The method of claim 39 wherein the subscriber station simulator comprises a mobile telephone simulator.

42. A test fixture, comprising:
first simulation means for simulating a communications device;
second simulation means for simulating an access point; and
controller means, coupled to the first and second means, for evaluating a unit under test.

43. The test fixture of claim 42 wherein the first simulation means comprises means for simulating a subscriber station, and the second simulation means comprises means for simulating a base station controller simulator.

44. The test fixture of claim 43 wherein the means for simulating a subscriber station comprises means for simulating a mobile data communications device.

45. The test fixture of claim 43 wherein the means for simulating a subscriber station comprises means for simulating a mobile telephone.

46. The test fixture of claim 42 further comprising a simulator board having the first and second simulation means thereon.

47 The test fixture of claim 42 wherein the second simulation means comprises means for communicating with the unit under test over an Ethernet network.

48. The test fixture of claim 42 further comprising means for interfacing the first simulation means with the unit under test over a wireless link.

49. The test fixture of claim 48 wherein first simulation means further comprises means for communicating with the unit under test using code division multiple access.

50. The test fixture of claim 49 wherein the first simulation means further comprises means for communicating with the unit under test using code and time division multiple access.

51. The test fixture of claim 42 wherein the controller means comprises means for for evaluating the unit under test in real time.

52. The test fixture of claim 42 wherein the first simulation means comprises means for establishing a first communications link with the unit under test, and the second simulation means comprises means for establishing a second communications link with the unit under test for the simulation means in response to the establishment of the first communications link.

53. Computer readable media embodying a method of testing a unit, the method comprising:
simulating a communications device to communicate with a unit under test;
simulating an access point to communicate with the unit under test; and
correlating in real time the communications of the simulated communications device and the simulated access point.

54. The computer readable media of claim 53 wherein the simulation of the communications device is configured to communicate with the unit under tests using a wireless link.

55. The computer readable media of claim 54 wherein the simulation of the communications device is further configured to communicate with the unit under test further comprises using code division multiple access.

56. The computer readable media of claim 55 wherein simulation of the communications device is further configured to communicate with the unit under test using code and time division multiple access.

57. The computer readable media of claim 53 wherein the simulation of the access point is configured to communicate with the unit under test using an Ethernet connection.

58. The computer readable media of claim 53 wherein the simulation of the communications device is configured to establish a first communications link with the unit under test, and the simulation of the access point is configured to attempt to establish a second communications link with the unit under test for the simulated communications device in response to the establishment of the first communications link.

59. The computer readable media of claim 58 wherein the correlation of the communications of the simulated communications device and the simulated access point comprises declaring a fault if the second communications link is not established in response to the establishment of the first communication link.

60. The computer readable media of claim 53 wherein the simulation of the communications device comprises simulating a subscriber station to communicate with the unit under test, and the simulation of the access point comprises simulating a base station controller to communicate with the unit under test.
